(19) United States
(12) Patent Application Publication
(10) Pub. No.: US 2026/0289120 A1
(43) Pub. Date: Sep. 24, 2026

(54) SYSTEMS AND METHODS FOR DYNAMICALLY GENERATING SERVICES AND USER INTERFACES BASED ON USER REQUESTS

(71) Applicant: Verizon Patent And Licensing Inc., Basking Ridge, NJ (US)

(72) Inventors: Ravi Kiran TUMMALA, Hyderabad (IN); Lokesh KOSURI, Hyderabad (IN); Naga Venkata Raja Rajeswari TEDLA, Bangalore (IN); Vishal AGARWAL, Hyderabad (IN); Abhishek ROYCHOUDHURY, Hyderabad (IN)

(73) Assignee: Verizon Patent And Licensing Inc., Basking Ridge, NJ (US)

(21) Appl. No.: 19/082,414

(22) Filed: Mar. 18, 2025

(51) Int. Cl. G06F 40/284; G06F 8/61; G06F 9/451; G06F 11/3668

(52) U.S. Cl. CPC G06F 40/284; G06F 8/61; G06F 9/451; G06F 11/3688

(57) ABSTRACT

A device may receive a request for a service, and may process the request, with a machine learning tokenizer, to generate tokens representing elements of the request. The device may determine whether an existing service satisfies the request based on the tokens. The device may selectively serve the request with the existing service based on the existing service satisfying the request, or may dynamically generate, based on the existing service failing to satisfy the request, a new service based on the tokens and using a large language model.

### BACKGROUND

In the realm of digital services, the ability to provide real-time, customized responses to user requests may be paramount for satisfaction and engagement. As technology progresses, user expectations have grown concerning the level of personalization, speed, and adaptability of digital interactions.

### BRIEF DESCRIPTION OF THE DRAWINGS

FIGS. 1A-1I are diagrams of an example associated with dynamically generating services and user interfaces based on user requests.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for dynamically generating services and user interfaces based on user requests.

### DETAILED DESCRIPTION OF EXAMPLE EMBODIMENTS

The following detailed description of example implementations refers to the accompanying drawings. The same reference numbers in different drawings may identify the same or similar elements.

Conventional software systems typically depend on predefined services and static user interfaces, and are unable to adapt to unique or changing user demands, often leading to a gap between the service provided and the service expected. In many scenarios, users encounter obstacles when their requests do not conform to the limited scope of existing services. They are confronted with unyielding systems that deliver generic responses or error messages. Furthermore, conventional software systems do not incorporate real-time customization, based on comprehensive user profiles, into their frameworks. Moreover, as users are increasingly mobile and expect seamless, uninterrupted access to services across various touchpoints, the conventional software systems struggle to keep pace. A one-size-fits-all approach to service provision and user interface design does not cater to the diverse needs and preferences of heterogeneous user bases. Thus, current techniques for providing services and user interfaces consume computing resources (e.g., processing resources, memory resources, communication resources, and/or the like), networking resources, and/or other resources associated with failing to create a personalized service experience for each user, handling user dissatisfaction, missing opportunities for enhancing engagement through tailored content delivery, requiring redundant manual service development and deployment, and/or the like.

Some implementations described herein provide a service system that dynamically generates services and user interfaces based on user requests. For example, the service system may receive a request for a service, and may process the request, with a machine learning tokenizer, to generate tokens representing elements of the request. The service system may determine whether an existing service satisfies the request based on the tokens. The service system may selectively serve the request with the existing service based on the existing service satisfying the request, or may dynamically generate, based on the existing service failing to satisfy the request, a new service based on the tokens and using a large language model.

In this way, the service system dynamically generates services and user interfaces based on user requests. For example, the service system provides dynamic generation and adaptation of digital services and user interfaces in real-time to fulfill custom user requests. When no existing service is capable of satisfying a request for a service, the service system may dynamically generate a new service via the proposed system, that incorporates machine learning models, such as small and large language models (SLMs and LLMs), and/or the like. The service system may integrate the new service with existing services and may permanently deploy the new service based on demand for the new service. To efficiently manage deployment, the service system may utilize automated deployment pipelines and infrastructure-as-code scripts, which are executed with dynamic parameter values generated by the LLM. Moreover, the service system may generate custom user interfaces for new services using user profile data. Thus, the service system may conserve computing resources, networking resources, and/or other resources that would have otherwise been consumed by failing to create a personalized service experience for each user, handling user dissatisfaction, missing opportunities for enhancing engagement through tailored content delivery, requiring redundant manual service development and deployment, and/or the like.

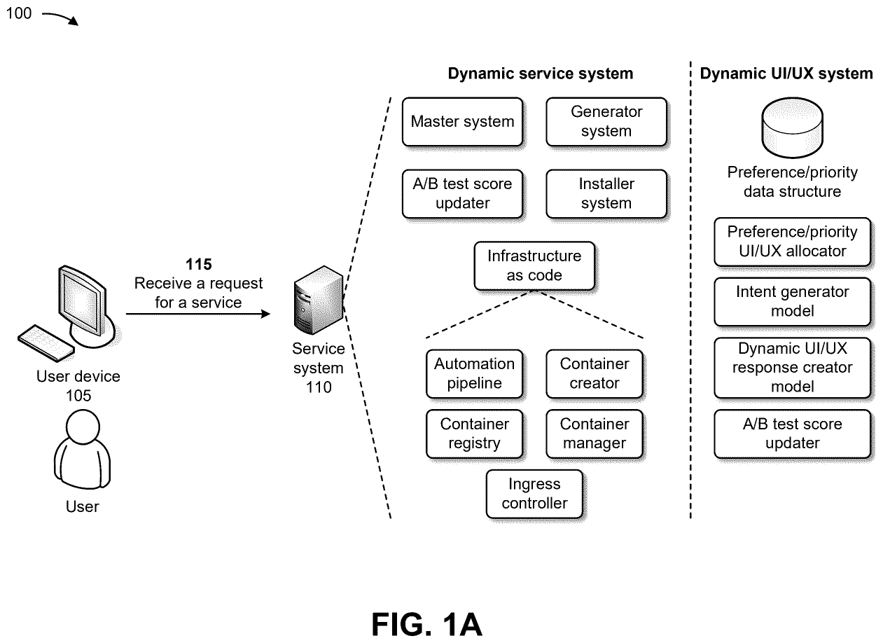

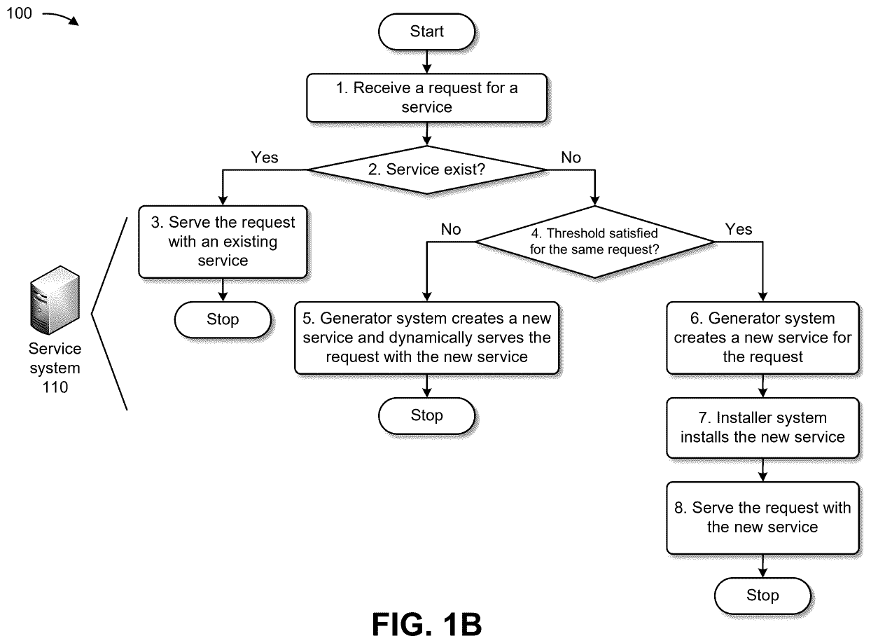

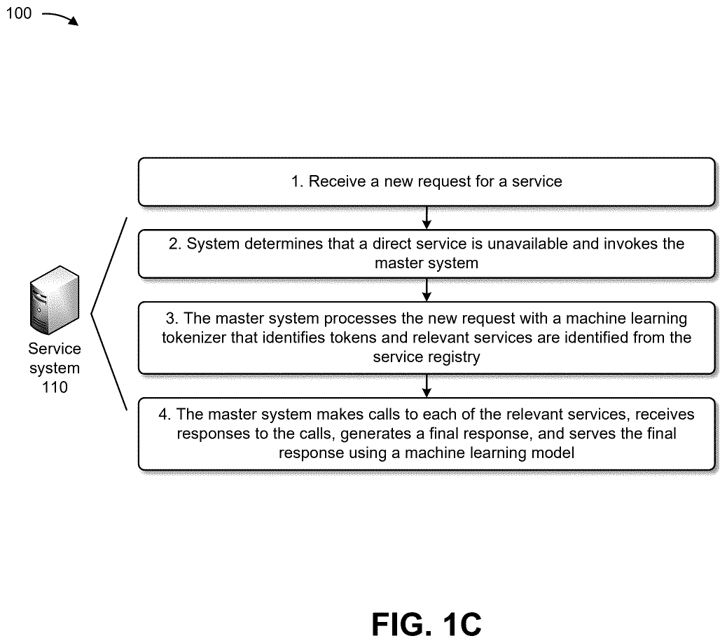

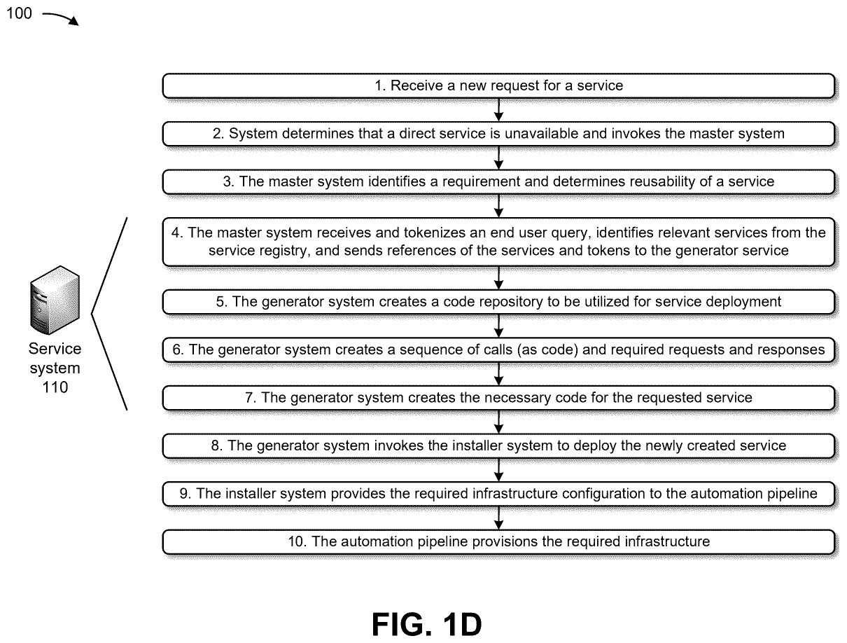

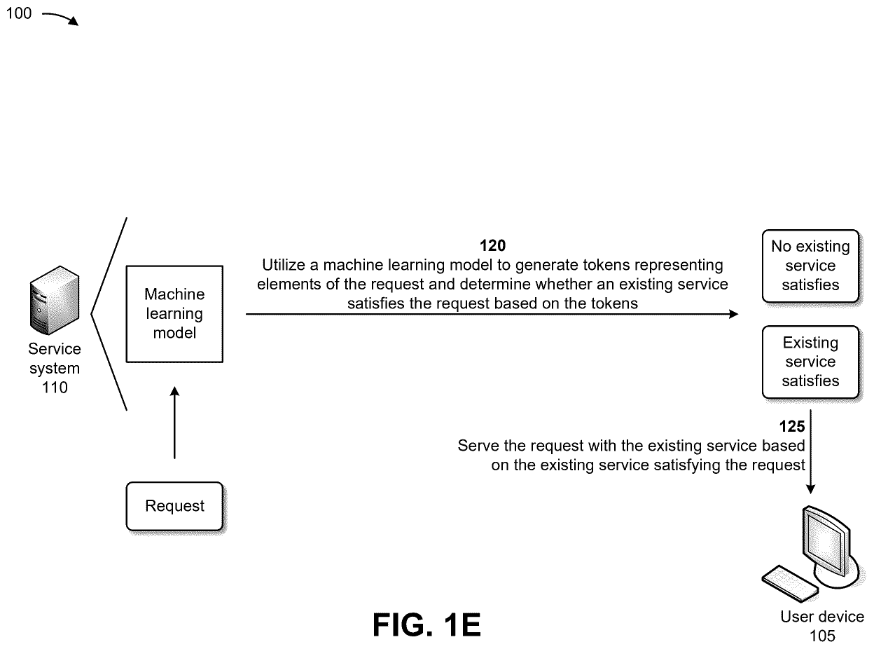

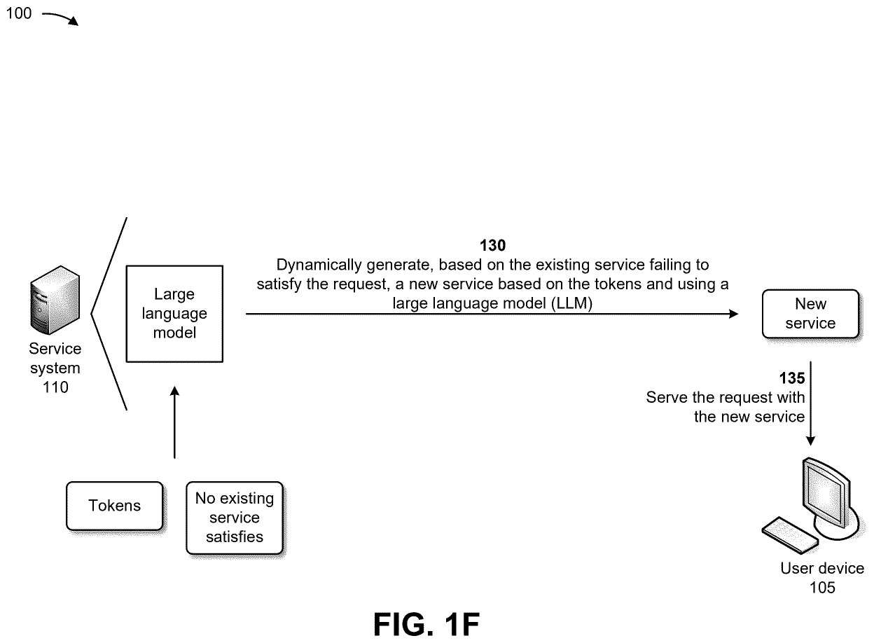

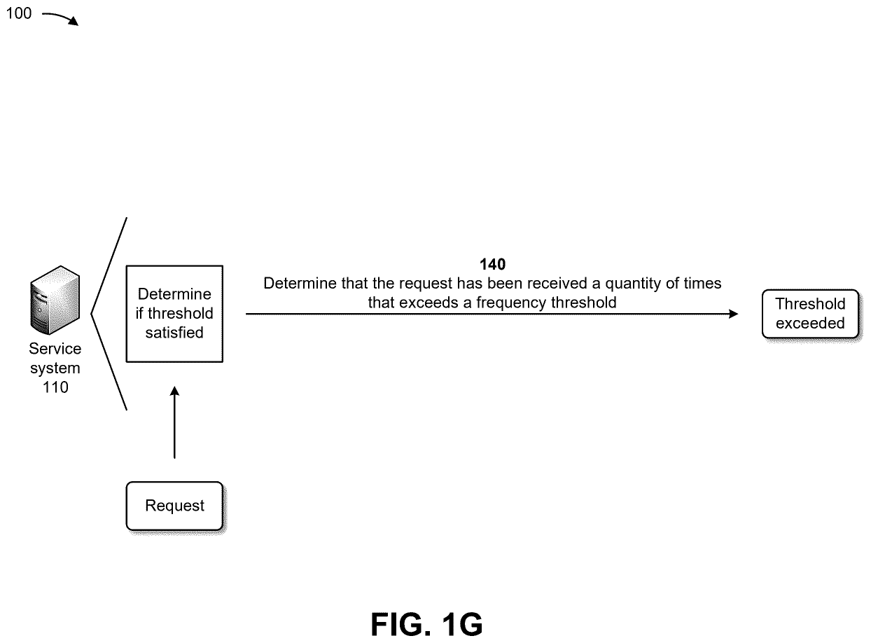

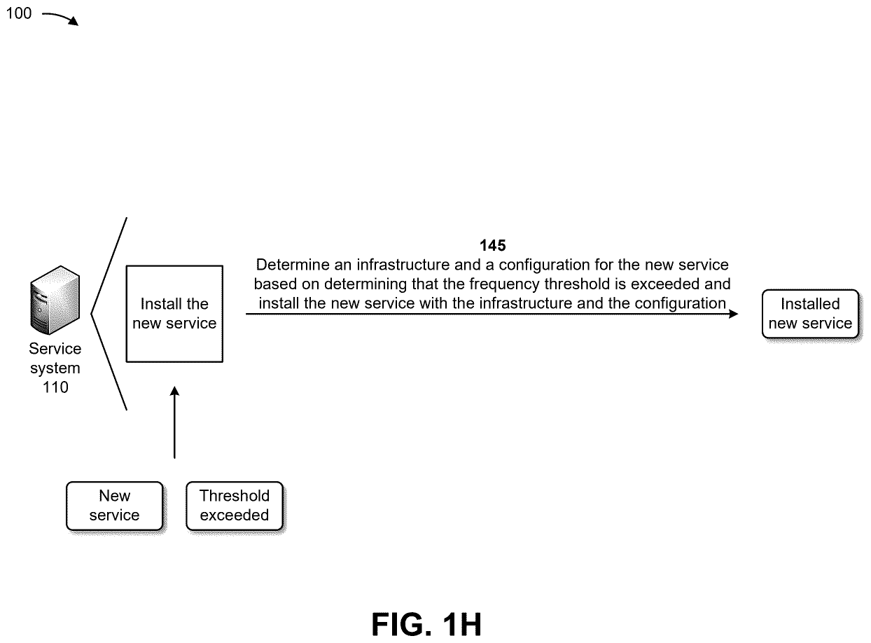

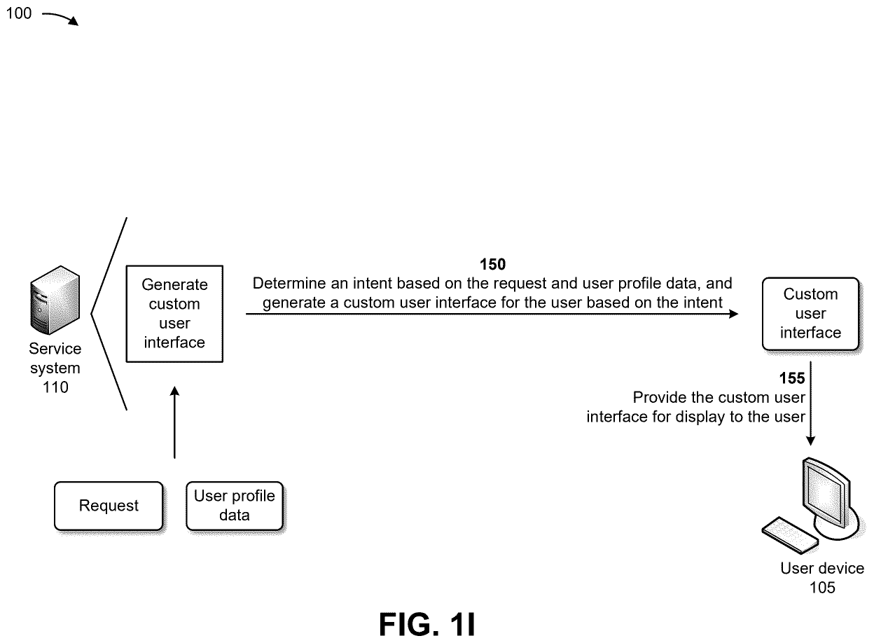

FIGS. 1A-1I are diagrams of an example 100 associated with dynamically generating services and user interfaces based on user requests. As shown in FIGS. 1A-1I, the example 100 includes a user device 105 associated with a user and a service system 110. The user device 105 may enable the user to provide, to the service system 110, requests for services provided by the service system 110. The service system 110 may include a system that dynamically generates services and user interfaces based on user requests. Further details of the user device 105 and the service system 110 are provided elsewhere herein. Although implementations described herein depict a single user device 105, in some implementations, the service system 110 may be associated with multiple user devices 105.

As shown in FIG. 1A, the service system 110 may include a dynamic service system and a dynamic user interface (UI)/user experience (UX) system. The dynamic service system may include a master system, a generator system, an installer system, an A/B test score updater, an infrastructure-as-code component, an automation pipeline (e.g., Jenkins or the like), a container creator, a container registry, a container manager component, and an ingress controller. The dynamic UI/UX system may include a preference/priority data structure, a preference/priority UI/UX allocator, an intent generator model, a dynamic UI/UX response creator model, and an A/B test score updater.

When a user provides a request for a service, the master system may receive the request and may analyze a service registry that includes parameters and responses for different services. If the service is an existing service in the service registry, the master system may serve the existing service to the user device 105. If the service is not in the service registry, the master system may interact with a machine learning model and an LLM. The machine learning model may decode request statements into tokens and may identify respective services from the service registry based on the tokens. For example, if a user types in “What would be my bill if I purchase music for six months?” The master system may identify “bill,” “music,” and “six months” as tokens and may attempt to identify existing services related to bills and subscriptions. Once the machine learning model gathers the information from responses from the service registry, the master system may attempt to combine the information to generate a new service based on requirements of the request.

The generator system may utilize machine learning and LLM capabilities to intelligently (as described below) create new services by understanding user intent and contextual data. When a request for a service is received, the generator system may process the request using the LLM, and the LLM may interpret the request and may extract relevant context from existing code repositories, service registries, and past service interactions. By using tokenization and embeddings, the LLM may map the user intent to potential solutions within an existing service ecosystem. If no matching service is found, the LLM may generate a new service by combining relevant code snippets, microservices, and functional modules from a codebase. The generator system may integrate the new service into the existing service ecosystem, and may dynamically generate a custom service tailored to the user's needs.

Contextual understanding may enable the LLM to optimize the generated service by selecting the most efficient models, frameworks, and application programming interfaces (APIs) based on historical data and performance metrics. If a service is recurrently requested, the generator system may permanently deploy the new service and may register the new service in a service catalog for future scalability. This automated, context-driven approach ensures that the service system 110 evolves and adapts seamlessly, reducing the need for manual intervention and expediting service deployment cycles.

The installer system may utilize an LLM to understand the necessary infrastructure requirements for the new service. The LLM may analyze the infrastructure requirements and may generate dynamic parameter values. The dynamic parameter values may be provided to the automation pipeline. The A/B test score updater may receive, from the user, feedback associated with the new service. The A/B test score updater may score the feedback and may provide feedback and the score to the master system for updating and fine tuning the generator system to produce best results.

The automation pipeline may define and manage a software delivery process. The automation pipeline may receive the dynamic parameter values from the installer system, and may utilize the dynamic parameter values to execute infrastructure-as-code scripts, such as CloudFormation or Terraform. The infrastructure-as-code (IaC) component may treat infrastructure as code, and may enable automated provisioning and management of resources, such as containers and EC2 instances. Infrastructure-as-code templates may be predefined with placeholders to allow for flexibility. The dynamic parameter values received from the LLM may populate the placeholders in the infrastructure-as-code templates through the automation pipeline. Upon execution of the automation pipeline, the new service may be installed along with an infrastructure and a configuration.

The automated deployment pipelines may be based on continuous integration/continuous deployment (CI/CD) tools, such as Jenkins and GitLab CI. These pipelines may be configured to automatically build, test, and deploy new services as containers. The IaC templates used during deployment may be written in languages such as HashiCorp Configuration Language (HCL) for Terraform or JSON/YAML for AWS CloudFormation. The dynamic parameter values generated by the LLM may include configurations, such as container specifications, environment variables, and resource allocations required for the efficient operation of new services. These values may be programmatically inserted into IaC templates before deployment, ensuring that all service instances are provisioned according to the specified requirements.

The container creator may create a container image for the new service created by the LLM. The container image may be deployed and executed on any platform that supports containers, such as Kubernetes, Docker Swarm, and/or the like. The container image created for the new service may be provided to the container registry (e.g., a fully managed container registry). The container manager component may receive the container image from the container registry and may deploy the container image in a container cluster. The container manager component may handle scaling and failover of applications, and may provide a framework to resiliently execute distributed systems.

The ingress controller may be deployed in the cluster and may be available for external access. Required routes and rules for the new service may be configured in the ingress controller. The ingress controller may act as an application layer load balancer and may allow external traffic to be routed to the services based on the routes and the rules.

The preference/priority data structure may include a database, a list, a table, and/or the like that includes user profile data, such as age, demographics, location, and/or the like. The preference/priority data structure may store all preferences or priorities from different channels. The preference/priority UI/UX allocator may be a central system that orchestrates between different systems. When the request for the service is received from the user, the preference/priority UI/UX allocator may retrieve the user preferences/priorities from the preference/priority data structure, and may provide the user preferences/priorities to the intent generator model.

The intent generator model may receive the user preferences/priorities, and may determine an intent based on the user preferences/priorities. The intent generator model may provide the intent to downstream systems for generation of a UI/UX response based on the intent. The intent generator model may receive feedback from the A/B test score updater, and may utilize the feedback to correct or make changes to the intent generator model.

The dynamic UI/UX response creator model may create a UI/UX response based on the intent received from the intent generator model. The UI/UX response created by the dynamic UI/UX response creator model may be dynamically rendered onto a display (e.g., of the user device 105). The A/B test score updater may receive feedback from the preference/priority UI/UX allocator, and may score the feedback. The A/B test score updater may provide the feedback and the score to the intent generator model for updating and fine tuning so that usage is maximized.

In this integrated system, communication between the master system, the generator system, the installer system, and other components may be facilitated using asynchronous message queues. Each subsystem may publish status updates and results to a central message broker, such as RabbitMQ® or Kafka®. This broker may ensure that all parts of the service system 110 have access to the latest information and state changes, enabling real-time adjustments and task allocations. The generator system, for example, may subscribe to tokenized request events and may utilize pre-defined APIs to pull data from the service registry and user profile database, creating a seamless flow of information across the entire infrastructure.

As further shown by FIG. 1A, and by reference number 115, the service system 110 may receive a request for a service. For example, the user may utilize the user device 105 to generate the request for the service, and the user device 105 may provide the request for the service to the service system 110. The service system 110 may receive the request for the service from the user device 105. In some implementations, the request may include a request for an existing service provided by an ecosystem (e.g., an Enterprise service system and/or the service system 110). Alternatively, the request may include a request for a new service not provided by the ecosystem.

FIG. 1B depicts a flow chart of an example process capable of being performed by the service system 110. As shown at step 1, the service system 110 may receive a request for a service. As shown at step 2, the service system 110 may determine whether the service already exists. For example, the LLM of the service system 110 may determine whether the service matches an existing service. If the service system 110 determines that the service matches an existing service (e.g., step 2—Yes), the service system 110 may serve the request with the existing service, as shown at step 3. If the service system 110 determines that the service does not exist (e.g., step 2—No), the service system 110 may determine whether a threshold is satisfied for the same request, as shown at step 4. For example, the service system 110 may determine whether a quantity of the same request satisfies a threshold level of requests.

If the service system 110 determines that the quantity of the same request fails to satisfy the threshold level (step 4—No), the service system 110 may utilize the generator system to create a new service and may dynamically service the request with the new service, as shown at step 5. If the service system 110 determines that the quantity of the same request satisfies the threshold level (step 4—Yes), the service system 110 may utilize the generator system to create the new service, as shown at step 6. Further details of step 6 are provided below in connection with FIGS. 1C and 1D. As shown at step 7, the service system 110 may utilize the installer system to install the new service (e.g., in the service ecosystem). As shown at step 8, the service system 110 may serve the request with the installed new service. Further details of step 6

FIG. 1C depicts an example flow chart associated with creating a new service when the threshold level is not satisfied. As shown at step 1 of FIG. 1C, the service system 110 may receive a new request for a service. As shown at step 2, the service system 110 may determine that a direct service is unavailable and may invoke the master system. As shown at step 3, the master system may process the new request with a machine learning tokenizer that identifies tokens and relevant services are identified from the service registry. As shown at step 4, the master system may make calls to each of the relevant services, may receive responses to the calls, may generate a final response, and may serve the final response using a machine learning model.

FIG. 1D depicts an example flow chart associated with creating a new service when the threshold level is satisfied. As shown at step 1 of FIG. 1D, the service system 110 may receive a new request for a service. As shown at step 2, the service system 110 may determine that a direct service is unavailable and may invoke the master system. As shown at step 3, the master system may identify a requirement and may utilize a threshold mechanism to determine reusability of a service based on historical data. As shown at step 4, the master system may receive and tokenize an end user query, may identify relevant services from the service registry, and may send references of the services and tokens to the generator service, wherein the tokens include information about required input and output from a service. As shown at step 5, the generator system may create a code repository to be utilized for service deployment. As shown at step 6, the generator system may analyze payloads of the services provided by the master system and may create a sequence of calls (as code), and required requests and responses, using the tokens shared by the master system. As shown at step 7, the generator system may create the necessary code for the requested service by referring to existing services and a code base on which the code is trained. As shown at step 8, the generator system may invoke the installer system to deploy the newly created service. As shown at step 9, the installer system may identify the required infrastructure configuration and provides it as values (e.g., required virtual servers, container configurations, load balancer configurations, etc.) to place holders of the automation pipeline. As shown at step 10, the automation pipeline may execute the IaC script to provision the required infrastructure, deploy the service, and update the service registry with the newly created service details.

As shown in FIG. 1E, and by reference number 120, the service system 110 may utilize a machine learning model to generate tokens representing elements of the request and may determine whether an existing service satisfies the request based on the tokens. For example, the machine learning model included in the service system 110 may process the request to generate tokens that represent different elements of the request. The tokens may enable the service system 110 to identify key elements, such as keywords and relevant data points in the request. The machine learning model may map the tokens to potential services within an existing service directory, and may determine whether any existing services satisfy the request based on mapping the tokens to the potential services. In some implementations, the service system 110 may include a machine learning tokenizer to parse the request into discrete tokens that are then analyzed to identify whether an existing service can handle the request. In some implementations, the service system 110 may determine that an existing service satisfies the request based on the tokens. Alternatively, the service system 110 may determine that no existing service satisfies the request based on the tokens.

The machine learning tokenizer may utilize a multi-layered neural network architecture. Initially, the tokenizer may extract words, phrases, and relevant features from the request text. The tokenizer may then apply a sequence-to-sequence model, utilizing long short-term memory (LSTM) networks to parse the input into tokens. Each token may represent significant elements of the request, such as action verbs, service identifiers, and temporal elements. The tokenizer may be pre-trained on a large corpus of service-related requests to accurately identify and categorize request components. This pre-training step may include fine-tuning on a dataset derived from historical service requests and responses to ensure context-aware token generation.

As further shown in FIG. 1E, and by reference number 125, the service system 110 may serve the request with the existing service based on the existing service satisfying the request. For example, if the machine learning model determines that the tokens match tokens associated with an existing service, the service system 110 may serve the request with the existing service by providing the existing service to the user device 105. Through this process, the service system 110 may efficiently and dynamically respond to user requests based on machine learning capabilities that analyze and match requests with existing services. In some implementations, the service system 110 may confirm that the existing service can satisfy the requirements indicated by the tokens and may deliver an appropriate response to the user device 105. This may ensure that the user receives prompt and accurate service based on the request.

As shown in FIG. 1D, and by reference number 130, the service system 110 may dynamically generate, based on the existing service failing to satisfy the request, a new service based on the tokens and using a large language model (LLM). For example, the service system 110 may utilize the tokens generated by the machine learning tokenizer to determine that no existing service satisfies the request. Upon this determination, the service system 110 may interact with an LLM to dynamically generate a new service that is tailored to specific requirements of the request. The dynamic generation of the new service may include the service system 110 utilizing a contextual understanding of the request and combining relevant portions of multiple existing services, such as code snippets, microservices, and functional modules, to create the new service. This process may enable the service system 110 to provide real-time customization of services that optimally satisfy user demands.

In some implementations, the service system 110 may store information about the new service in a service registry, allowing for future retrieval and reuse. This may enable the service system 110 to keep a record of the generated new services for future reference and usage. Additionally, or alternatively, the service system 110 may integrate the new service with existing services, which may ensure seamless operation within a current service ecosystem and may enhance compatibility. This integration ensures that the new service operates smoothly with pre-existing services without causing any disruption. Additionally, or alternatively, the service system 110 may modify the user interface associated with the request to reflect the new service, which may provide users with an updated and more relevant interaction experience. The update to the user interface may ensure that the user interaction is synchronized with the new service.

The LLM may be based on a transformer architecture, similar to models like GPT-3 and BERT. The LLM may be trained on vast amounts of service interaction data to understand and generate human-like text. In operation, the LLM may receive the tokens generated by the tokenization process and may utilize attention mechanisms to highlight contextually relevant parts of the request. The LLM may then synthesize this information to generate new service definitions or adapt existing services. Training of the LLM may include multiple epochs of supervised learning on a diversified dataset, including service commands, customer interactions, and system logs, to ensure robustness and accuracy.

As further shown in FIG. 1D, and by reference number 135, the service system 110 may serve the request with the new service. For example, once the new service is generated, the service system 110 may deploy the new service and may provide a response to the request using the new service. This may ensure that the user receives a response that accurately addresses the request, even when no existing service matches the request. In some implementations, if the service system 110 detects a high frequency of similar requests, the service system 110 may permanently deploy the new service by updating the service registry, which may ensure that future identical requests are automatically handled by the new service. This may enable the service system 110 to efficiently handle recurring requests by permanently deploying the new service. Additionally, or alternatively, the service system 110 may utilize automated deployment pipelines and IaC scripts to provision and install the new service with minimal manual intervention, speeding up deployment times and reducing potential errors. This automation ensures quick and error-free deployment of the new service. Thus, the service system 110 may enhance user experience and satisfaction by dynamically adapting to user needs and providing personalized service solutions.

As shown in FIG. 1G, and by reference number 140, the service system 110 may determine that the request has been received a quantity of times that exceeds a frequency threshold. For example, the service system 110 may analyze incoming requests and may determine that the same or similar request has been received a quantity of times based on analyzing the requests. In some implementations, the service system 110 may compare tokens generated for the requests to determine that the requests are the same or similar. The service system 110 may then determine that the quantity of times (e.g., the frequency of the same request), that the same or similar request is received, exceeds the frequency threshold. This determination may be based on the service system 110 identifying a pattern of recurrent requests that exceed the frequency threshold, which signifies high demand for a specific service that may not currently exist or is seldomly matched by existing services. Upon identifying that the quantity of times exceeds the frequency threshold, the service system 110 may flag the request for generating a new permanent service to automatically handle such recurring requests more efficiently in the future.

As shown in FIG. 1H, and by reference number 145, the service system 110 may determine an infrastructure and a configuration for the new service based on determining that the frequency threshold is exceeded and may install the new service with the infrastructure and the configuration. For example, the service system 110 may analyze incoming requests and determine that the quantity of the same or similar request has exceeded the frequency threshold. Upon this determination, the service system 110 may determine a required infrastructure and configuration necessary to support the new service. The service system 110 may utilize a machine learning model to assess the infrastructure needs, such as types of instances, load balancing requirements, storage resources, and/or the like. The configuration may include configurations for the infrastructure needs, such as a load balancer configuration, a storage resource configuration, and/or the like.

Once the infrastructure and the configuration are identified, the service system 110 may initiate the installation of the new service. For example, the service system 110 may execute the infrastructure-as-code templates using derived dynamic parameters and provisioning required resources efficiently. The new service may subsequently be installed within the existing service ecosystem, ensuring seamless integration and readiness for handling future requests. The process of dynamically determining and installing the new service contributes to resource optimization and scalability, reducing manual intervention and expediting service deployment cycles.

As shown in FIG. 1I, and by reference number 150, the service system 110 may determine an intent based on the request and user profile data, and may generate a custom user interface for the user based on the intent. For example, the service system 110 may use the request along with the user profile data to determine an intent that represents the user's requirements or desired actions. The user profile data may include various details about the user, such as preferences, past interactions, demographic information, and other relevant data. This information may enable the service system 110 to determine the user's context and personalize the user interface accordingly. In some implementations, the service system 110 may utilize the intent generator model to determine the intent based on the request and user profile data. Additionally, or alternatively, the intent generator model of the service system 110 may include a machine learning model that identifies user behavior patterns and predicts preferences. Based on the user behavior patterns and the preferences, the service system 110 can generate an intent, which effectively encapsulates the predicted requirements or actions of the user. Additionally, or alternatively, the service system 110 may integrate various user data sources to enrich the user profile and improve intent accuracy. The integration of extensive user data sources, such as browsing history, interaction logs, and service usage patterns, may significantly bolster an ability of the service system 110 to discern user intent with higher precision and thereby generate a superior custom user interface.

In some implementations, the service system 110 may utilize the determined intent to generate a custom user interface for the user. For example, the service system 110 can utilize the details from the request and the stored user profile data to ascertain what the user may need or prefer, and then may utilize this information to generate a user interface that is tailored to the user's needs and/or preferences. In some implementations, the service system 110 may utilize the intent to create a dynamic and personalized user interface that may include specific themes, layout changes, or interactive functionalities that align closely with the user's preferences.

As further shown in FIG. 1I, and by reference number 155, the service system 110 may provide the custom user interface for display to the user. For example, once the custom user interface has been generated, the service system 110 may provide the custom user interface to the user device 105, and the user device 105 may display the custom user interface to the user. This may enable the user to interact with a service in a way that is more aligned with the user's preferences and needs. The custom user interface may include various forms, such as a chat assistant interface, a customized web page, or a mobile application interface that changes dynamically based on the user's interactions and preferences. In some implementations, the service system 110 may continuously refine the custom user interface based on real-time feedback. For example, the service system 110 may utilize a feedback loop where ongoing user interactions are analyzed to refine and improve the custom user interface, ensuring an ever-evolving and increasingly personalized user experience.

In this way, the service system 110 dynamically generates services and user interfaces based on user requests. For example, the service system 110 provides dynamic generation and adaptation of digital services and user interfaces in real-time to fulfill user requests with customization. When an existing service fails to satisfy a request for a service, the service system 110 may dynamically generate a new service via an LLM. The service system 110 may integrate the new service with existing services and may permanently deploy the new service based on demand for the new service. To efficiently manage deployment, the service system 110 may utilize automated deployment pipelines and infrastructure-as-code scripts, which are executed with dynamic parameter values generated by the LLM. Moreover, the service system 110 may generate custom user interfaces for new services using user profile data. Thus, the service system 110 may conserve computing resources, networking resources, and/or other resources that would have otherwise been consumed by failing to create a personalized service experience for each user, handling user dissatisfaction, missing opportunities for enhancing engagement through tailored content delivery, requiring redundant manual service development and deployment, and/or the like.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

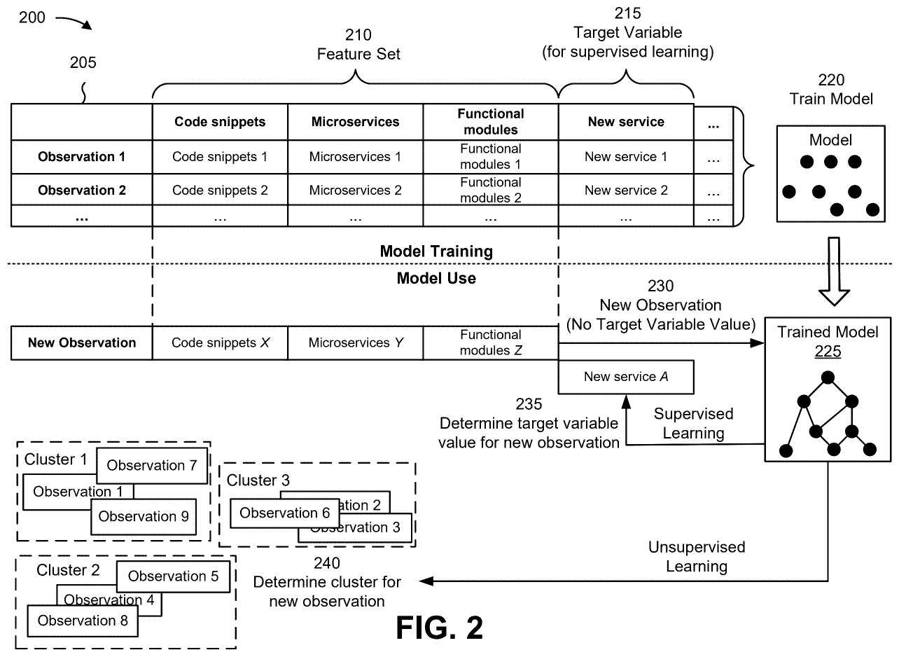

FIG. 2 is a diagram illustrating an example 200 of training and using a machine learning model. The machine learning model training and usage described herein may be performed using a machine learning system. The machine learning system may include or may be included in a computing device, a server, a cloud computing environment, and/or the like, such as the service system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the service system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the service system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of code snippets, a second feature of microservices, a third feature of functional modules, and so on. As shown, for a first observation, the first feature may have a value of code snippets 1, the second feature may have a value of microservices 1, the third feature may have a value of functional modules 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “new service” and may include a value of new service 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of code snippets X, a second feature of microservices Y, a third feature of functional modules Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of new service A for the target variable of the new service for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a code snippets cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a microservices cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to dynamically generate services and user interfaces based on user requests. The machine learning system enables recognition and/or identification of tens, hundreds, thousands, or millions of features and/or feature values for tens, hundreds, thousands, or millions of observations, thereby increasing accuracy and consistency and reducing delay associated with dynamically generating services and user interfaces based on user requests relative to requiring computing resources to be allocated for tens, hundreds, or thousands of operators to manually generate services and user interfaces based on user requests.

As indicated above, FIG. 2 is provided as an example. Other examples may differ from what is described in connection with FIG. 2.

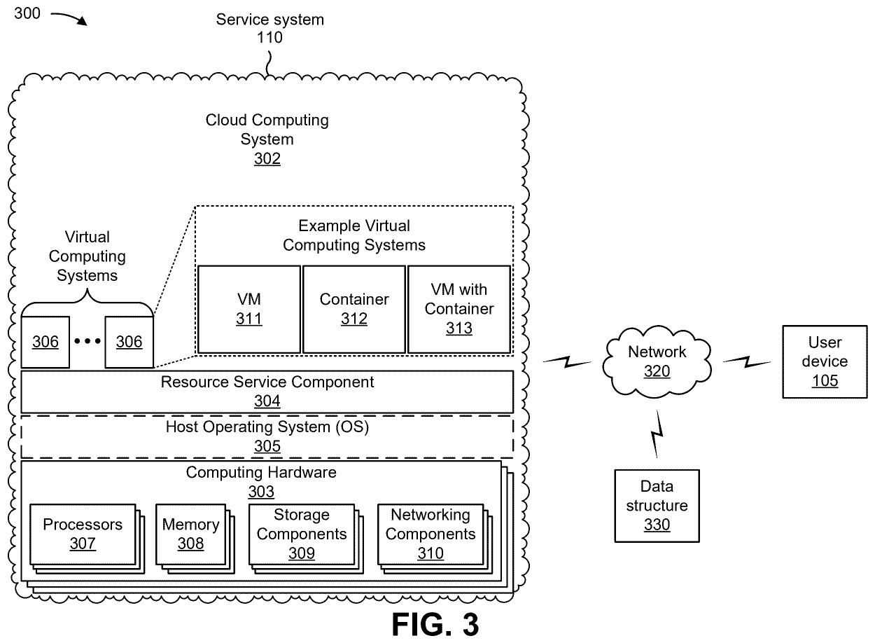

FIG. 3 is a diagram of an example environment 300 in which systems and/or methods described herein may be implemented. As shown in FIG. 3, the environment 300 may include the service system 110, which may include one or more elements of and/or may execute within a cloud computing system 302. The cloud computing system 302 may include one or more elements 303-313, as described in more detail below. As further shown in FIG. 3, the environment 300 may include a user device 105, a network 320, and/or a data structure 330. Devices and/or elements of the environment 300 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

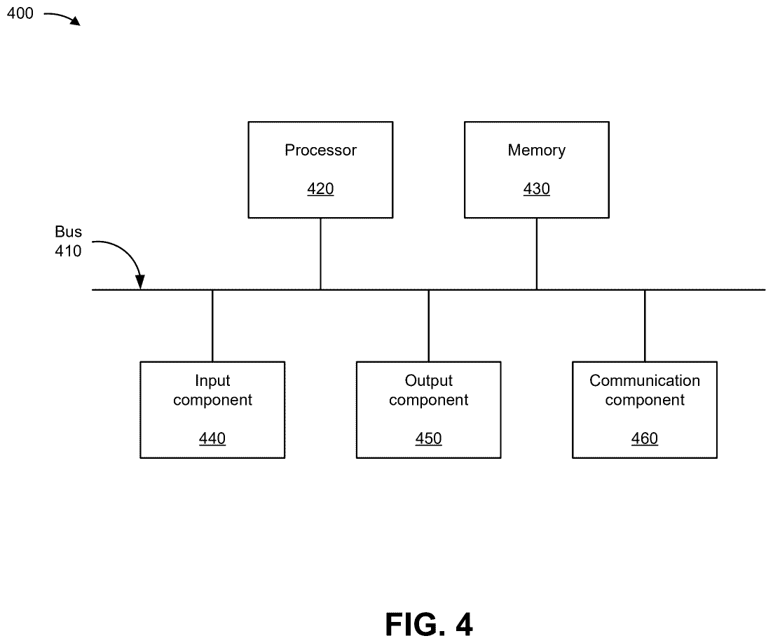

Although the service system 110 may include one or more elements 303-313 of the cloud computing system 302, may execute within the cloud computing system 302, and/or may be hosted within the cloud computing system 302, in some implementations, the service system 110 may not be cloud-based (e.g., may be implemented outside of a cloud computing system) or may be partially cloud-based. For example, the service system 110 may include one or more devices that are not part of the cloud computing system 302, such as a device 400 of FIG. 4, which may include a standalone server or another type of computing device. The service system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of the environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the user device 105, the service system 110, and/or the data structure 330. In some implementations, the user device 105, the service system 110, and/or the data structure 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

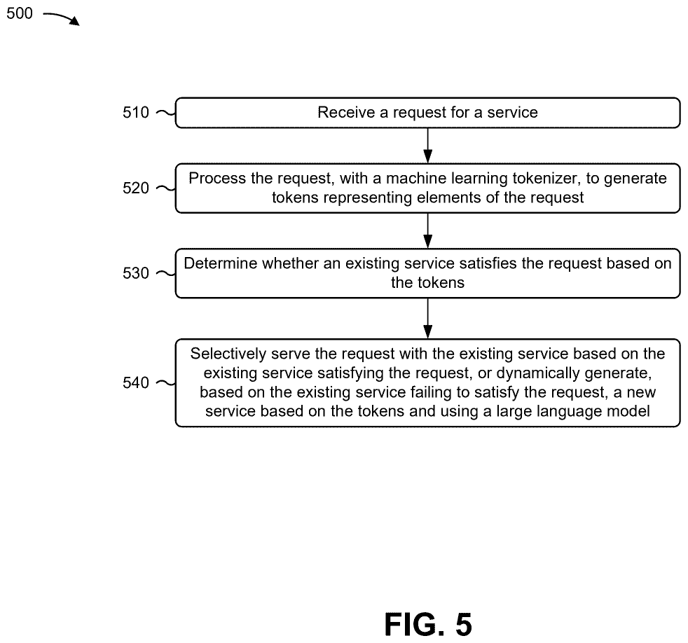

FIG. 5 depicts a flowchart of an example process 500 for dynamically generating services and user interfaces based on user requests. In some implementations, one or more process blocks of FIG. 5 may be performed by a device (e.g., the service system 110). In some implementations, one or more process blocks of FIG. 5 may be performed by another device or a group of devices separate from or including the device, such as a user device (e.g., the user device 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving a request for a service (block 510). For example, the device may receive a request for a service, as described above.

As further shown in FIG. 5, process 500 may include processing the request, with a machine learning tokenizer, to generate tokens representing elements of the request (block 520). For example, the device may process the request, with a machine learning tokenizer, to generate tokens representing elements of the request, as described above.

As further shown in FIG. 5, process 500 may include determining whether an existing service satisfies the request based on the tokens (block 530). For example, the device may determine whether an existing service satisfies the request based on the tokens, as described above. In some implementations, determining whether the existing service satisfies the request includes mapping the tokens to potential service solutions within an existing service directory, and determining whether the existing service satisfies the request based on mapping the tokens to the potential service solutions.

As further shown in FIG. 5, process 500 may include selectively serving the request with the existing service based on the existing service satisfying the request, or dynamically generating, based on the existing service failing to satisfy the request, a new service based on the tokens and using a large language model (block 540). For example, the device may selectively serve the request with the existing service based on the existing service satisfying the request, or dynamically generate, based on the existing service failing to satisfy the request, a new service based on the tokens and using a large language model, as described above. In some implementations, dynamically generating the new service includes combining relevant portions of multiple existing services to generate the new service.

In some implementations, process 500 includes deploying the new service, and providing a response to the request using the new service. In some implementations, process 500 includes storing information associated with the request and the new service in a service registry. In some implementations, process 500 includes integrating the new service with existing services provided by the device.

In some implementations, process 500 includes conducting automated testing of different user interface designs based on the request, and providing feedback based on the automated testing and to optimize user interaction. In some implementations, process 500 includes generating a custom user interface for the new service based on user profile data associated with a user that generated the request, and providing the new service, for display to the user, via the custom user interface. In some implementations, the custom user interface includes one or more of a chat assistant user interface, a web-based form user interface, or a mobile application user interface.

In some implementations, process 500 includes receiving recurring requests for the new service, determining that a quantity of the recurring requests exceeds a frequency threshold, and permanently deploying the new service based on the quantity of the recurring requests exceeding the frequency threshold. In some implementations, process 500 includes utilizing automated deployment pipelines and infrastructure-as-code scripts to provision and install the new service in a service system. In some implementations, the infrastructure-as-code scripts are executed using dynamic parameter values generated by the large language model. In some implementations, process 500 includes modifying a user interface associated with the request to reflect the new service.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving, by a device, a request for a service;
processing, by the device, the request, with a machine learning tokenizer, to generate tokens representing elements of the request;
determining, by the device, whether an existing service satisfies the request based on the tokens; and
selectively:
serving, by the device, the request with the existing service based on the existing service satisfying the request; or
dynamically generating, by the device and based on the existing service failing to satisfy the request, a new service based on the tokens and using a large language model.

2. The method of claim 1, further comprising:
deploying the new service; and
providing a response to the request using the new service.

3. The method of claim 1, further comprising:
storing information associated with the request and the new service in a service registry.

4. The method of claim 1, wherein determining whether the existing service satisfies the request comprises:
mapping the tokens to potential service solutions within an existing service directory; and
determining whether the existing service satisfies the request based on mapping the tokens to the potential service solutions.

5. The method of claim 1, further comprising:
integrating the new service with existing services provided by the device.

6. The method of claim 1, wherein dynamically generating the new service comprises:
combining together relevant portions of multiple existing services to generate the new service.

7. The method of claim 1, further comprising:
conducting automated testing of different user interface designs based on the request; and
providing feedback based on the automated testing and to optimize user interaction.

8. A device, comprising:
one or more processors configured to:
receive a request for a service;
process the request, with a machine learning tokenizer, to generate tokens representing elements of the request;
determine whether an existing service satisfies the request based on the tokens; and selectively:
serve the request with the existing service based on the existing service satisfying the request; or
dynamically generate, based on the existing service failing to satisfy the request, a new service based on the tokens and using a large language model, and deploy the new service.

9. The device of claim 8, wherein the one or more processors are further configured to:
generate a custom user interface for the new service based on user profile data associated with a
user that generated the request; and
provide the new service, for display to the user, via the custom user interface.

10. The device of claim 9, wherein the custom user interface includes one or more of a chat assistant user interface, a web-based form user interface, or a mobile application user interface.

11. The device of claim 8, wherein the one or more processors are further configured to:
receive recurring requests for the new service;
determine that a quantity of the recurring requests exceeds a frequency threshold; and
permanently deploy the new service based on the quantity of the recurring requests exceeding the frequency threshold.

12. The device of claim 8, wherein the one or more processors are further configured to:
utilize automated deployment pipelines and infrastructure-as-code scripts to provision and install the new service in a service system.

13. The device of claim 12, wherein the infrastructure-as-code scripts are executed using dynamic parameter values generated by the large language model.

14. The device of claim 8, wherein the one or more processors are further configured to:
modify a user interface associated with the request to reflect the new service.

15. A non-transitory computer-readable medium storing a set of instructions, the set of instructions comprising:
one or more instructions that, when executed by one or more processors of a device, cause the device to:
receive a request for a service;
process the request, with a machine learning tokenizer, to generate tokens representing elements of the request;
determine whether an existing service satisfies the request based on the tokens; and
selectively:
serve the request with the existing service based on the existing service satisfying the request; or
dynamically generate, based on the existing service failing to satisfy the request, a new service based on the tokens and using a large language model, and modify a user interface associated with the request to reflect the new service.

16. The non-transitory computer-readable medium of claim 15, wherein the one or more instructions further cause the device to:
deploy the new service; and
provide a response to the request using the new service.

17. The non-transitory computer-readable medium of claim 15, wherein the one or more instructions, that cause the device to determine whether the existing service satisfies the request, cause the device to:
map the tokens to potential service solutions within an existing service directory; and
determine whether the existing service satisfies the request based on mapping the tokens to the potential service solutions.

18. The non-transitory computer-readable medium of claim 15, wherein the one or more instructions, that cause the device to dynamically generate the new service, cause the device to:
combine together relevant portions of multiple existing services to generate the new service.

19. The non-transitory computer-readable medium of claim 15, wherein the one or more instructions further cause the device to:
conduct automated testing of different user interface designs based on the request; and
provide feedback based on the automated testing and to optimize user interaction.

20. The non-transitory computer-readable medium of claim 15, wherein the one or more instructions further cause the device to:
generate a custom user interface for the new service based on user profile data associated with a user that generated the request; and
provide the new service, for display to the user, via the custom user interface.
